(19) United States
(12) Patent Application Publication
(10) Pub. No.: US 2023/0004871 A1
(43) Pub. Date: Jan. 5, 2023

(54) MACHINE LEARNING CLUSTER PIPELINE FUSION

(71) Applicant: Advanced Micro Devices, Inc., Santa Clara, CA (US)

(72) Inventors: Swapnil P. Sakharshete, San Diego, CA (US); Maxim V. Kazakov, San Diego, CA (US); Milind N. Nemlekar, San Diego, CA (US); Samuel Lawrence Wasmundt, San Diego, CA (US)

(73) Assignee: Advanced Micro Devices, Inc., Santa Clara, CA (US)

(21) Appl. No.: 17/364,787

(22) Filed: Jun. 30, 2021

(51) Int. Cl. G06N 20/10; G06F 9/38; G06F 9/30; G06F 17/16; G06N 3/02

(52) U.S. Cl. CPC G06N 20/10; G06F 9/3867; G06F 9/30141; G06F 9/3887; G06F 17/16; G06N 3/02

(57) ABSTRACT

Methods, systems, and devices for pipeline fusion of a plurality of kernels. In some implementations, a first batch of a first kernel is executed on a first processing device to generate a first output of the first kernel based on an input. A first batch of a second kernel is executed on a second processing device to generate a first output of the second kernel based on the first output of the first kernel. A second batch of the first kernel is executed on the first processing device to generate a second output of the first kernel based on the input. The execution of the second batch of the first kernel overlaps at least partially in time with executing the first batch of the second kernel.

### BACKGROUND

Machine learning (e.g., deep learning) is widely used in a variety of technologies (e.g., image classification) to make predictions or decisions to perform a particular task (e.g., whether an image includes a certain object). For example, a convolutional neural network (CNN) is a class of deep learning algorithms widely used in machine learning applications. These networks typically include multiple layers. At each layer, a set of filters is applied to the output of previous layer, and the outputs of each layer are written to and read from memory.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating example components of an accelerated processing device for implementing one or more features of the present disclosure;

FIG. 4 is a block diagram illustrating example components of a GPU shown in FIG. 3 with additional detail;

FIG. 5 is a block diagram illustrating example interconnections between components of the accelerated processing device shown in FIG. 4;

FIG. 6 is a flow diagram illustrating an example machine learning task;

FIG. 7 is a block diagram illustrating example operations of execution of kernels of a dot-product operation; and

FIG. 8 is a flow chart illustrating an example method for pipeline fusion of a first kernel and a second kernel.

### DETAILED DESCRIPTION

Machine learning models typically use significant memory bandwidth, which can lead to bandwidth bottlenecks, negatively impacting performance, and increasing power consumption. The amount of memory used to store output data at different layers of machine learning neural networks is typically large enough that the data cannot be saved in on-chip memory. Accordingly, storing the data includes transfer of the data to and from off-chip memory.

Deep learning algorithms (e.g., CNNs, recurrent neural networks and other forms of artificial neural networks) typically include matrix multiplication operations. Accelerated processors, such as GPUs, have been used to perform matrix multiplication using techniques which employ parallelization to increase the efficiency of matrix multiplication. For example, two matrices are typically divided into smaller portions (e.g., columns, rows, and portions of columns and rows) and a matrix multiplication operation of the two matrices is performed by executing a plurality of matrix multiplication computations each including the multiplication of a portion of one matrix with a portion of another matrix. The matrix multiplication computations are mapped to and executed by different processor cores of a processor network to perform the matrix multiplication operation.

Conventional GPU architectures are not well suited for machine learning. Operations processed during execution of machine learning applications, typically include a series of operations, such as matrix multiplication operations followed by other operations (e.g., post matrix multiplication operations, such as point operations) in which operations are performed using the data resulting from the matrix multiplication operations. The data resulting from the matrix multiplication operations is processed, during these post matrix multiplication operations, in the CUs of the GPU. Accordingly, if sufficient bandwidth is not available for the CUs to access the resulting data, bottlenecks occur. The cache subsystem architecture (e.g., L1, L2 cache and so on) of conventional GPUs does not, however, typically have capacities large enough to hold intermediate data, e.g., between neural network layers, and accordingly, CUs typically fetch data from slower system memory, which negatively impacts the overall performance.

It may be desired to provide a GPU architecture which instantiates dedicated arithmetic logic units ALUs which are separate from each CU, and which are configured to perform matrix multiplication operations and post matrix multiplication operations.

For example, matrix multiplication typically includes reusable data. When two matrices are multiplied, the data for the first matrix is used for multiple blocks of the second matrix. Thus, the same data for the first matrix is fetched repeatedly into different CUs to multiply with blocks of another matrix. That is, bottlenecks (i.e., matrix multiplication bottlenecks) may result because the same data is inefficiently fetched multiple times, e.g., from the cache subsystem architecture of the GPU, for the dedicated arithmetic logic units ALUs in each CU.

Some implementations provide accelerated processors designed for data reuse which include interconnects between the ALUs instantiated in each CU for data sharing between CUs to reduce these matrix multiplication bottlenecks. In some implementations, these dedicated accelerated processors, however, are not well suited for executing non-matrix multiplication operations.

Accordingly, some implementations provide devices and methods for efficiently executing matrix multiplication operations and non-matrix multiplication operations. Features of the present disclosure include ALUs instantiated separately from the CUs, and dedicated ALU interconnects connecting the ALUs and configured to provide shared access to data by the CUs. In some implementations, each ALU includes its own register file, which may be referred to as a “scratchpad” memory, for storing the data provided to the ALUs and receiving data resulting operations executed on the ALUs, such as matrix multiplication calculations. In some implementations, the register files are accessible by each CU to store data which the ALUs use to perform certain operations (e.g., matrix multiplication), and accessible by each CU to read the data to perform other operations (e.g., softmax, scaling, or other non-matrix-multiplication or post-matrix-multiplication operations).

Some implementations provide a method for pipeline fusion of a plurality of kernels. A first batch of a first kernel is executed on a first processing device to generate a first output of the first kernel based on an input. A first batch of a second kernel is executed on a second processing device to generate a first output of the second kernel based on the first output of the first kernel. A second batch of the first kernel is executed on the first processing device to generate a second output of the first kernel based on the input. The execution of the second batch of the first kernel overlaps at least partially in time with executing the first batch of the second kernel.

In some implementations, a first batch of a third kernel is executed to generate a first output of the third kernel based on the first output of the second kernel. In some implementations, executing the first batch of the third kernel overlaps at least partially in time with executing the second batch of the second kernel. In some implementations, a second batch of the third kernel is executed to generate a second output of the third kernel based on the second output of the second kernel, and concatenating the first output of the third kernel is concatenated with the second output of the third kernel to generate an output of the plurality of kernels. In some implementations, the first output of the first kernel is written to a scratch memory of the first processing device by the first processing device. In some implementations, the first output of the first kernel is read from the scratch memory of the first processing device by the second processing device. In some implementations, the first output of the first kernel is written to a register file of the first processing device by the first processing device. In some implementations, the first output of the first kernel is read from the register file of the first processing device by the second processing device. In some implementations, the first processing device includes an arithmetic logic unit (ALU). In some implementations, the second processing device includes a compute unit (CU). In some implementations, the first kernel performs a matrix multiply operation and the second kernel does not perform a matrix multiply operation.

Some implementations provide a processor configured for pipeline fusion of a plurality of kernels. The processor includes a first processing device configured to execute a first batch of a first kernel to generate a first output of the first kernel based on an input. The processor also includes a second processing device configured to execute a first batch of a second kernel to generate a first output of the second kernel based on the first output of the first kernel. The first processing device is configured to execute a second batch of the first kernel to generate a second output of the first kernel based on the input. The first processing device is also configured to execute the second batch of the first kernel overlapping in time at least partially with the second processing device executing the first batch of the second kernel.

In some implementations, the first processing device is configured to execute a first batch of a third kernel to generate a first output of the third kernel based on the first output of the second kernel. In some implementations, the first processing device is configured to execute the first batch of the third kernel overlapping at least partially in time with the second processing device executing the second batch of the second kernel. In some implementations, the first processing device is configured to execute a second batch of the third kernel to generate a second output of the third kernel based on the second output of the second kernel. In some implementations, the processor includes circuitry configured to concatenate the first output of the third kernel with the second output of the third kernel to generate an output of the plurality of kernels. In some implementations, the first processing device is configured to write the first output of the first kernel to a scratch memory of the first processing device. In some implementations, the second processing device is configured to read the first output of the first kernel from the scratch memory of the first processing device. In some implementations, the first processing device is configured to write the first output of the first kernel is to a register file of the first processing device. In some implementations, the second processing device is configured to read the first output of the first kernel from the register file of the first processing device. In some implementations, the first processing device comprises an arithmetic logic unit (ALU). In some implementations, the second processing device comprises a compute unit (CU). In some implementations, the processor includes circuitry configured to copy the first output of the first kernel from a scratch memory of the first processing device to a cache memory.

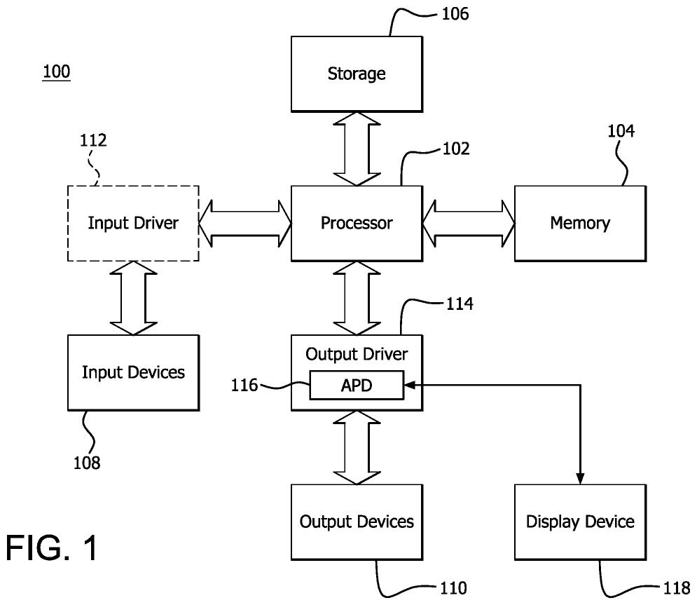

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm can also perform the functionality described herein.

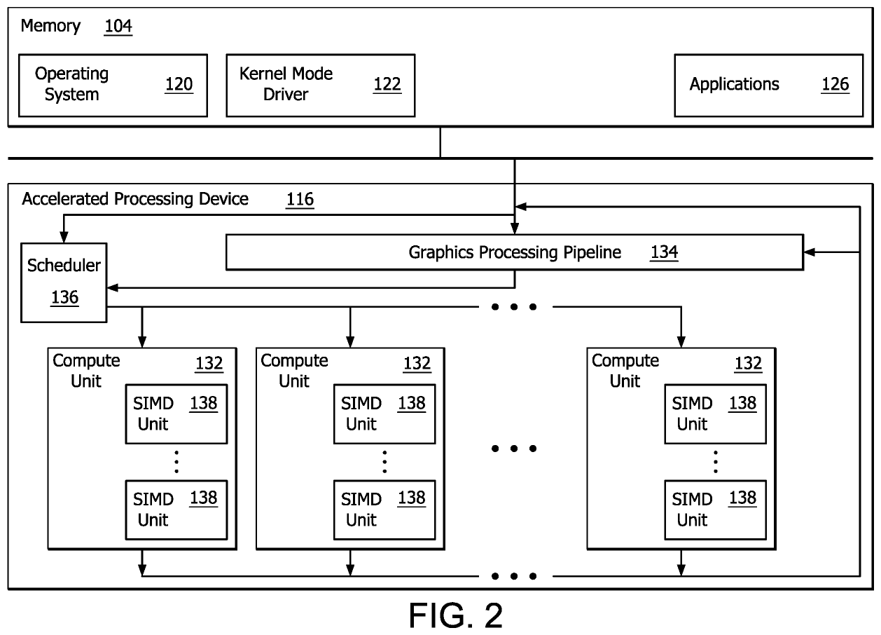

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with or using different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus, in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

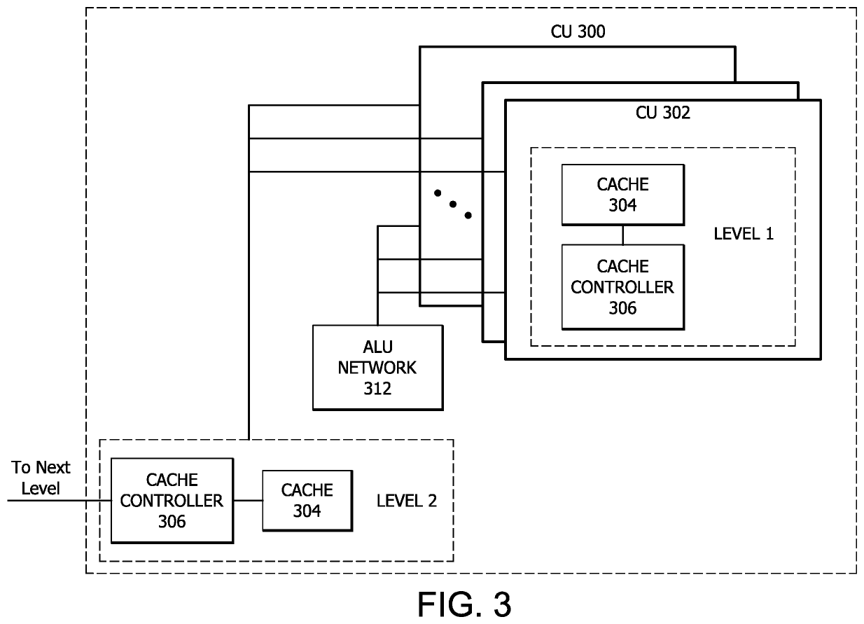

FIG. 3 is a block diagram illustrating example components of an accelerated processing device for implementing one or more features of the present disclosure. For simplified explanation, the accelerated processing device is described as a GPU 300. The GPU 300 is an example of an accelerated processing device.

As shown in FIG. 3, GPU 300 include a plurality of compute units 302. Each compute unit 302 includes a corresponding level 1 cache controller 306 in communication with a corresponding level 1 cache 304. As further shown in FIG. 3, GPU 300 includes a level 2 cache controller 310 in communication with level 2 cache 308. Level 2 cache 308 is shared by each of the CUs 302. Cache controller 310 can also be in communication with a next cache level (higher cache level), as indicated in FIG. 3.

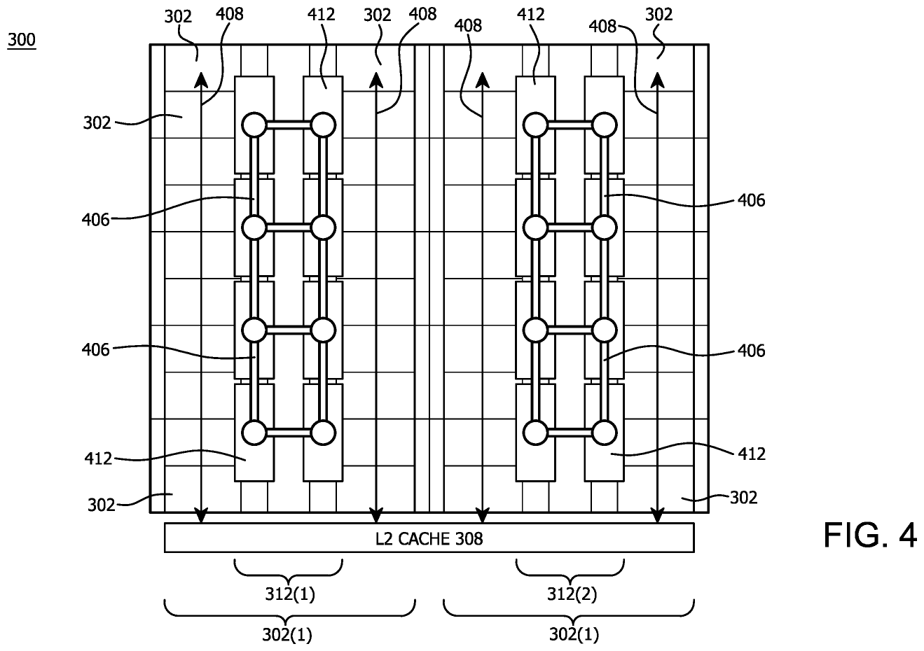

GPU 300 also includes ALU network 312. ALU network 312 includes a plurality of ALUs, instantiated separate from the CUs 302 as well as dedicated ALU interconnects, connecting the ALUs to provide shared access to data, by the CUs 302, in register files of the ALUs as described in more detail below with regard to FIG. 4.

FIG. 4 is a block diagram illustrating example components of the GPU 300 shown in FIG. 3 with additional detail. As shown in FIG. 4, GPU 300 includes a first group of CUs 302(1), a second group of CUs 301(2), a first ALU network 312(1), a second ALU network 312(2). The GPU 300 also includes GPU interconnects 306 for data access, by the CUs 302, to memory 104 (e.g., RAM, DRAM, cache memory and the like). The GPU 300 also includes clocks 404.

FIG. 4 illustrates two groups of CUs (i.e., 302(1) and 302(2)) and two ALU networks (i.e., 312(1) and 312(2)). The number of CU groups and 301(2)) and the number of ALU networks shown in FIG. 4 is merely an example. Features of the present disclosure can be implemented using any number CU groups and any number of ALU networks. FIG. 4 also illustrates twenty CUs 302 in each CU group (302(1) and 301(2)) and eight ALUs 412 in each ALU networks (312(1) and 312(2)). The number of CUs shown in each group and the number ALUs shown in each ALU network is merely an example. Features of the present disclosure can be implemented using any number of CUs per group and any number ALUs per ALU network.

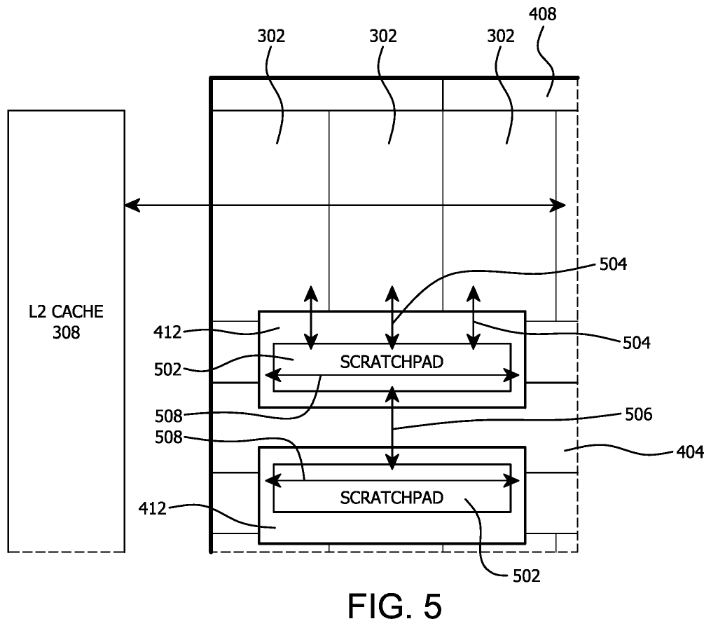

Each of the ALU networks 312(1) and 312(2) include a plurality of ALUs 412 and a plurality of interconnects 406. Each ALU 412 includes its own corresponding register file, such as for example scratchpad memory 502 shown in FIG. 5. The interconnects 406 provide each of the ALUs 412 with shared access to the data stored at other ALUs 412 for communication between the ALUs 412. The interconnects 406 also provide each of the CUs 302 with shared access to the data stored at any of the ALUs 412 for communication between the CUs 302. Accordingly, the register files (e.g., scratchpad memory 502) are used to store data provided to the ALUs 412 (e.g., by other ALUs 412 and CUs 302) and to store data resulting from performing calculations during execution of operations, such as matrix multiplication operations and post matrix multiplication operations. The data stored in the scratchpad memory 502 is also read from other ALUs 412 and CUs 302 to perform matrix multiplication calculations and perform post matrix multiplication operations.

GPU 300 also includes interconnects 408 which are used to communicate data between the CUs 302 and memory 104 (e.g., main memory and cache memory). The interconnects 408 are not used for data communication between ALUs 412.

FIG. 5 is a block diagram illustrating example interconnections between components of the accelerated processing device shown in FIG. 4. The arrows shown in FIG. 5 are used to represent interconnects between the ALUs and CUs 302. The register files of each ALU 412 is directly accessible by a plurality of CUs 302. For example, as indicated by arrow 504 in FIG. 5, the scratchpad memory 502 of the top ALU 412 in FIG. 5 is in direct communication with three of the CUs 302 (3 leftmost CUs 302 in FIG. 5) and is connected to the scratchpad memory 502 of the adjacent ALU 412 (as indicated by arrow 506). The scratchpad memories 502 of other ALUs 412 of the ALU network are connected via arrows 508. That is, the scratchpad memory 502 of the other ALUs 412 of a corresponding ALU network are indirect accessible by the top ALU 412 in FIG. 5 via the interconnects represented by arrows 506 and 508.

Machine learning tasks typically include both matrix multiplication operations (e.g., general matrix multiply (GEMM) operations) and operations that are not matrix multiplication operations. For example, in some cases a machine learning task includes a matrix multiplication of two variables, followed by a softmax operation on the result, followed by a matrix multiplication of the result of the softmax operation with a third variable.

In some implementations, the ALUs implement hardware for performing calculations that may be useful for machine learning applications, such as matrix multiplication operations, or convolution, and the CUs implement hardware configured for computations that are not matrix multiplication operations, such as scaling, softmax, masking, pooling, normalization, and other operations.

If all of the kernels of the machine learning task are executed on the same processor, these tasks would typically be performed consecutively due to data dependencies (e.g., the result of the first matrix multiplication kernel would be input to the softmax kernel, and the output of the softmax kernel would be input, along with the third variable, to the second matrix multiplication kernel. In such cases, delays accrue due to storing of the results of one kernel to memory from the register file, launching of the next kernel on the processor, and loading of the results of the prior kernel from memory back to the register file as input to the next kernel.

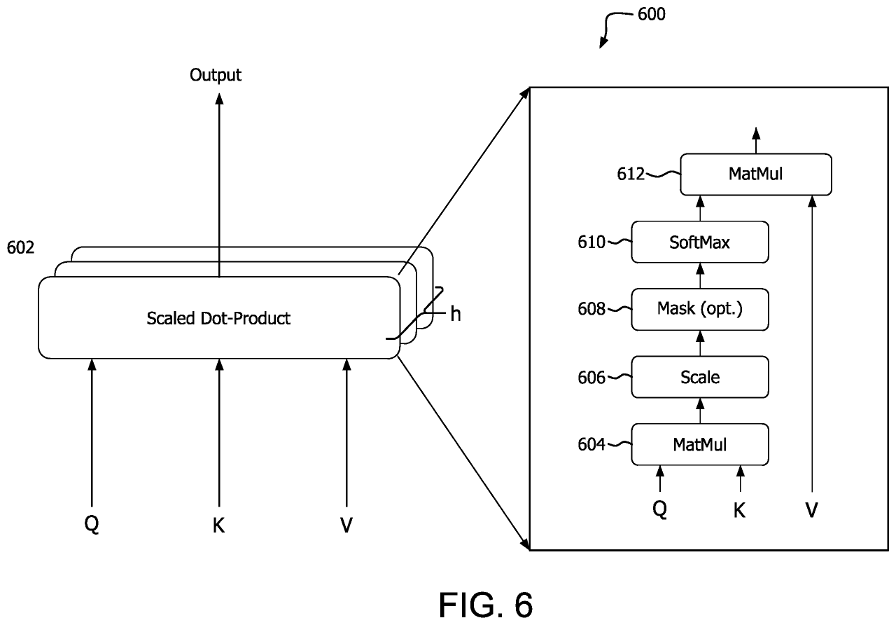

FIG. 6 is a flow diagram illustrating an example machine learning task 600 having three inputs Q, K, V, and one output. Machine learning task 600 includes a scaled dot-product operation 602. Scaled dot-product operation is performed on h sets of Q, K, V input data.

Machine learning task 600 includes several component kernels. For example, scaled dot-product operation 602 includes a matrix multiplication 604 of inputs Q and K (matrix multiplication 604 notated as Q*K for convenience), scaling 606, masking 608, and softmax 610 of the output of matrix multiplication 604 (where scaling 606, masking 608, and softmax 610 are notated as SM for convenience), and a matrix multiplication 612 of the output of softmax 610 and the input V (matrix multiplication 612 notated as QK*V for convenience).

If the kernels of scaled dot-product operation 602 were all executed by the same processor, execution would typically be performed serially, with matrix multiplication 604 followed by scaling 606, masking 608, softmax 610, and matrix multiplication 612, repeating for each of the h sets of Q, K, V input data. However, if matrix multiplication operations 604 and 612 are executable on an ALU (e.g., ALU 412) and non- or post-matrix multiplication operations (e.g., scaling 606, masking 608, softmax 610) are executable on a CU (e.g., CU 302), in some implementations, it is possible to pipeline execution of the kernels such that processing of different sets of Q, K, V input data can overlap, increasing processing speed.

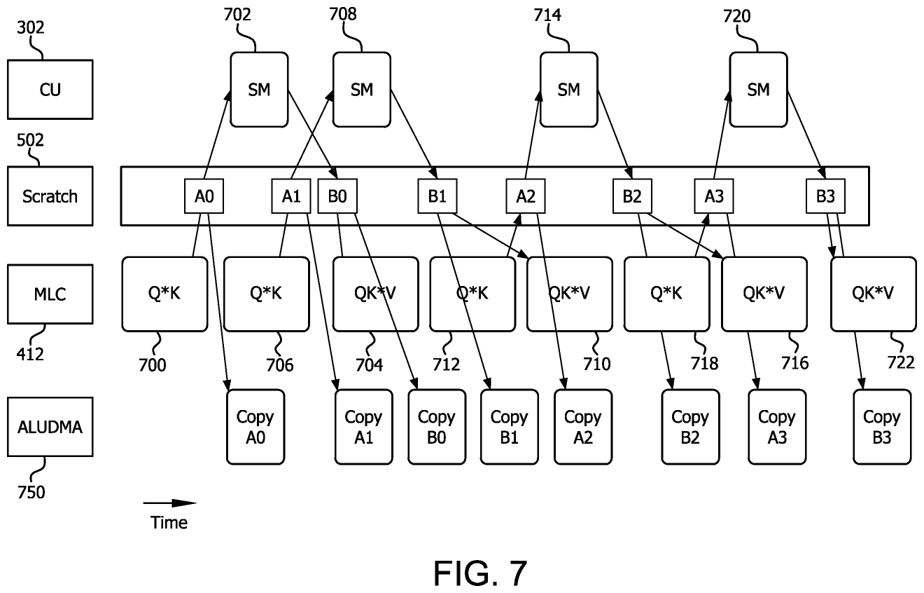

FIG. 7 is a block diagram illustrating example operations of a CU 302 and ALU 412 executing kernels of a dot-product operation for inputs Q, K, V. The dot-product operation includes a kernel which performs a GEMM of inputs Q, K (Q*K) a kernel which performs a softmax (SM) on the result of Q*K, and a GEMM of the result of the SM and input V (QK*V). CU 302, and ALU 412 store intermediate results in scratchpad 502, which enables pipelining of “unrolled” Q*K, SM, and QK*V kernels. Unrolling, in this context, refers to performing an operation (such as GEMM operation Q*K) in batches such that each batch produces a portion of the output, and not the entire output. The results of each batch are referred to as a result tile. In this example, each kernel is unrolled into 4 batches (i.e., unroll depth=4). The size of each result tile is based on the capacity of scratchpad 502, and the unroll depth. The final 4 result tiles are concatenated or otherwise processed to yield a final result.

Because the discrete GEMM and SM kernels are unrolled and pipelined to run during overlapping time periods, the two kernels can be referred to as “pipeline fused”. GEMM and SM kernels are merely examples. It is noted that any suitable type and/or number of kernels are pipeline fusable in a similar manner. For example, kernels are suitable for pipeline fusing where a GEMM or convolutional kernel is executed on an ALU, whereas a non-GEMM or non-convolutional kernel is executed on the CU. In this example, because all of the GEMM kernels are executed on ALU 412, and all SM kernels are executed on CU 302, it is possible for the unrolled matrix multiplication kernels and SM kernels to run simultaneously or during overlapping time periods. Accordingly, the corresponding kernels are unrolled to operate on inputs Q, K, V in 4 batches (0-3) in this example.

In this example, for batch 0, matrix multiplication Q*K is performed by executing kernel 700 on ALU 412, and the result tile A0 is stored in scratchpad 502. Softmax SM is performed on result tile A0 by executing kernel 702 on CU 302 and the result tile B0 is stored in scratchpad 502. Matrix multiplication QK*V is performed on result tile B0 by executing kernel 704 on ALU 412. The output of kernel 704 (not shown) is written to a global memory (e.g., memory 104), or to a different memory or cache, depending on the desired implementation. In cases where further operations are performed on the output of kernel 704, these results can be written to the scratchpad 502 instead.

For batch 1, matrix multiplication Q*K is performed by executing kernel 706 on ALU 412, and the result tile A1 is stored in scratchpad 502. In this example, kernel 706 begins executing on ALU 412 before batch 0 is complete, since the SM kernel 702 is executed on CU 302, and does not require the use of ALU 412. Softmax SM is performed on result tile A1 by executing kernel 708 on CU 302 and the result tile B1 is stored in scratchpad 502. In this example, kernel 708 begins executing on CU 304 before batch 0 is complete, since the QK*V kernel 704 is executed on ALU 412, and does not require the use of CU 302. Matrix multiplication QK*V is performed on result tile B1 by executing kernel 710 on ALU 412. The result tile of kernel 710 (not shown) is written to the scratchpad 502, or to a different memory, depending on the desired implementation.

For batch 2, matrix multiplication Q*K is performed by executing kernel 712 on ALU 412, and the result tile A2 is stored in scratchpad 502. In this example, kernel 712 begins executing on ALU 412 before batch 1 is complete, since the SM kernel 708 is executed on CU 302, and does not require the use of ALU 412. Softmax SM is performed on result tile A2 by executing kernel 714 on CU 302 and the result tile B2 is stored in scratchpad 502. In this example, kernel 714 begins executing on CU 304 before batch 1 is complete, since the QK*V kernel 710 is executed on ALU 412, and does not require the use of CU 302. Matrix multiplication QK*V is performed on result tile B2 by executing kernel 716 on ALU 412. The result tile of kernel 716 (not shown) is written to the scratchpad 502, or a different memory, depending on the desired implementation.

For batch 3, matrix multiplication Q*K is performed by executing kernel 718 on ALU 412, and the result tile A3 is stored in scratchpad 502. In this example, kernel 718 begins executing on ALU 412 before batch 2 is complete, since the SM kernel 714 is executed on CU 302, and does not require the use of ALU 412. Softmax SM is performed on result tile A1 by executing kernel 720 on CU 302 and the result tile B3 is stored in scratchpad 502. In this example, kernel 720 begins executing on CU 304 before batch 2 is complete, since the QK*V kernel 716 is executed on ALU 412, and does not require the use of CU 302. Matrix multiplication QK*V is performed on result B3 by executing kernel 722 on ALU 412. The output of kernel 722 (not shown) is written to the scratchpad 502, or a different memory, depending on the desired implementation.

In some implementations, executing the unrolled kernels during overlapping time periods on CU 302 and ALU 412 has the advantage of performing the operation in less time than would be possible the kernels were not unrolled, and were executed serially (e.g., due to waiting for the availability of results.)

It is noted that where the result of a first kernel is input to a second kernel in this example, in some implementations, the result of the first kernel is written to a register of the scratchpad that is designated as an input of the second kernel. Because the result stored and read from the scratchpad, which is a set of registers that is local to the ALU, and the result is not read back from a cache, memory, or other memory for input to the second kernel, performance is increased in some implementations; e.g., by reducing the latency that is due to memory storage operations.

FIG. 7 also illustrates example operations of ALUDMA 750, which is a memory access (e.g., direct memory access (DMA)) controller configured to copy information from registers of scratchpad 502 to a memory (e.g., off-chip memory or a cache memory). For example, in some implementations it may be desired to retain a copy of the intermediate results (e.g., for backpropagation training). ALUDMA 750 is configured to copy the information from the registers of scratchpad 502 to the memory. Copying information using hardware other than ALU 412 and CU 302, in some implementations, also has the advantage of increasing performance, e.g., by reducing the latency that is due to memory storage operations.

In the examples above, pipeline fusion is described for a GEMM and SM operation. As mentioned above however GEMM and SM kernels are merely examples of kernels which are pipeline fusable. It is noted that any suitable type and/or number of kernels are pipeline fusable in a similar manner, if they are capable of executing during overlapping time periods (e.g., by unrolling) on an ALU and CU as described above. For example, in some implementations, a gaussian error linear unit (GeLU) kernel and fully connected (FC) kernel are pipeline fusable. In another example, a rectified linear unit (ReLU) and FC operation are pipeline fusable.

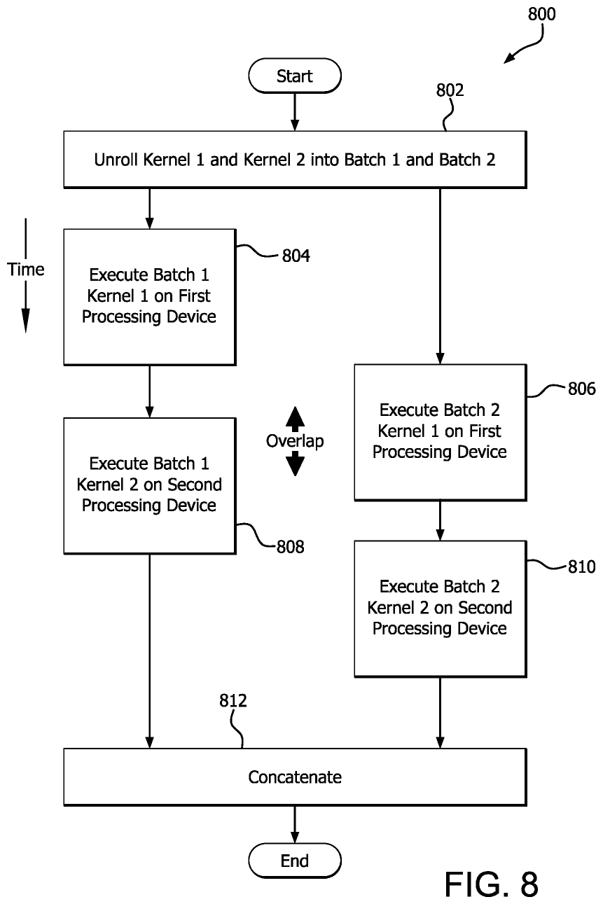

FIG. 8 is a flow chart illustrating an example method 800 for pipeline fusion of a first kernel and a second kernel. Method 800 is useable with any of the devices and techniques described above. Example method 800 pipeline fuses only two kernels in this example, using an unroll depth of 2, however it is noted that any suitable number of kernels can be pipeline fused using any suitable unroll depth in other implementations.

In step 802, kernel 1 and kernel 2 are unrolled into batch 1 and batch 2. In some implementations, kernel 1 is a matrix multiplication kernel in this example, and kernel 2 is a function that does not include matrix multiplication.

In step 804, batch 1 of kernel 1 is executed on a first processing device. In some implementations, the first processing device is an ALU. In some implementations, the first processing device is optimized for matrix multiplication operations. In some implementations, the result of the execution of batch 1 kernel 1 is written to a scratch memory or register file of the first processing device, or another local memory, e.g., as further discussed herein.

In step 806, after batch 1 of kernel 1 has completed execution on the first processing device, batch 2 of kernel 1 is executed on the first processing device. In some implementations, the result of the execution of batch 2 of kernel 1 is written to the scratch memory, register file, or other local memory.

In step 808, also after batch 1 of kernel 1 has completed execution on the first processing device, batch 1 of kernel 2 is executed on the second processing device. In some implementations, the second processing device is a CU. In some implementations, the second processing device is optimized for general purpose computation or otherwise not optimized for matrix multiplication operations. In some implementations, the result of the execution of batch 1 of kernel 2 is written to the scratch memory, register file, or other local memory. The execution of batch 1 of kernel 2 on the second processing device overlaps at least partially in time with the execution of batch 2 of kernel 1 on the first processing device.

In step 810, after batch 2 of kernel 1 has completed execution on the first processing device, batch 2 of kernel 2 is executed on the second processing device. In some implementations, the result of the execution of batch 2 of kernel 2 is written to the scratch memory, register file, or other local memory.

In step 812, the result of the execution of batch 1 of kernel 2 and the result of the execution of batch 2 of kernel 2 are concatenated to generate a result of the pipeline fused first kernel and second kernel. In some implementations, the overlap in execution exhibited during example method 800 has the advantage of facilitating generation of the result of the pipeline fused first kernel and second kernel in less time than generation of the result of the first kernel and second kernel without pipeline fusion.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for pipeline fusion of a plurality of kernels, the method comprising:
executing a first batch of a first kernel on a first processing device to generate a first output of the first kernel based on an input;
executing a first batch of a second kernel on a second processing device to generate a first output of the second kernel based on the first output of the first kernel; and
executing a second batch of the first kernel on the first processing device to generate a second output of the first kernel based on the input;
wherein executing the second batch of the first kernel overlaps at least partially in time with executing the first batch of the second kernel.

2. The method of claim 1, further comprising executing a first batch of a third kernel to generate a first output of the third kernel based on the first output of the second kernel;
wherein executing the first batch of the third kernel overlaps at least partially in time with executing the second batch of the second kernel.

3. The method of claim 2, further comprising executing a second batch of the third kernel to generate a second output of the third kernel based on the second output of the second kernel; and concatenating the first output of the third kernel with the second output of the third kernel to generate an output of the plurality of kernels.

4. The method of claim 1, wherein the first output of the first kernel is written to a scratch memory of the first processing device by the first processing device.

5. The method of claim 4, wherein the first output of the first kernel is read from the scratch memory of the first processing device by the second processing device.

6. The method of claim 1, wherein the first output of the first kernel is written to a register file of the first processing device by the first processing device.

7. The method of claim 6, wherein the first output of the first kernel is read from the register file of the first processing device by the second processing device.

8. The method of claim 1, wherein the first processing device comprises an arithmetic logic unit (ALU).

9. The method of claim 1, wherein the second processing device comprises a compute unit (CU).

10. The method of claim 1, wherein the first kernel performs a matrix multiply operation and the second kernel does not perform a matrix multiply operation.

11. A processor configured for pipeline fusion of a plurality of kernels, the processor comprising:
a first processing device configured to execute a first batch of a first kernel to generate a first output of the first kernel based on an input;
a second processing device configured to execute a first batch of a second kernel to generate a first output of the second kernel based on the first output of the first kernel; and
the first processing device further configured to execute a second batch of the first kernel to generate a second output of the first kernel based on the input;
wherein the first processing device is further configured to execute the second batch of the first kernel overlapping in time at least partially with the second processing device executing the first batch of the second kernel.

12. The processor of claim 11, wherein the first processing device is configured to execute a first batch of a third kernel to generate a first output of the third kernel based on the first output of the second kernel; and wherein the first processing device is configured to execute the first batch of the third kernel overlapping at least partially in time with the second processing device executing the second batch of the second kernel.

13. The processor of claim 12, wherein the first processing device is configured to execute a second batch of the third kernel to generate a second output of the third kernel based on the second output of the second kernel; the processor further comprising circuitry configured to concatenate the first output of the third kernel with the second output of the third kernel to generate an output of the plurality of kernels.

14. The processor of claim 11, wherein the first processing device is configured to write the first output of the first kernel to a scratch memory of the first processing device.

15. The processor of claim 14, wherein the second processing device is configured to read the first output of the first kernel from the scratch memory of the first processing device.

16. The processor of claim 11, wherein the first processing device is configured to write the first output of the first kernel is to a register file of the first processing device.

17. The processor of claim 16, wherein the second processing device is configured to read the first output of the first kernel from the register file of the first processing device.

18. The processor of claim 11, wherein the first processing device comprises an arithmetic logic unit (ALU).

19. The processor of claim 11, wherein the second processing device comprises a compute unit (CU).

20. The processor of claim 11, further comprising circuitry configured to copy the first output of the first kernel from a scratch memory of the first processing device to a cache memory.
